(19) United States
(12) Patent Application Publication
(10) Pub. No.: US 2003/0144391 A1
(43) Pub. Date: Jul. 31, 2003

(54) Laminate enhancer coating

(76) Inventor: Guenther Pollak, Wausau, WI (US)

Correspondence Address: Mathew E. Corr-Boyle Fredrickson,, Newholm Stein & Gratz, S. C., Suite 1030, 250 E. Wisconsin Avenue, Milwaukee, WI, 53202, US

(21) Appl. No.: 10/351,781

(22) Filed: Jan. 27, 2003

Related U.S. Application Data
(60) Provisional application No. 60/352,005, filed on Jan. 25, 2002.

(51) Int. Cl. C08K 5/34

(52) U.S. Cl. 524/99; 524/388; 524/501; 427/385.5; 428/423.1

(57) ABSTRACT

An enhancer coating for enhancing the appearance of laminate material including a protective exterior coating is provided. The enhancer coating includes a number of components including a number of emulsion agents capable of adhering the enhancer coating to the protective coating on the laminate material. The coating also includes a number of gloss enhancing agents which increase the gloss level of the laminate material. Multiple coats of the enhancer coating can also be utilized to obscure, cover and/or repair minor scratches, abrasions or other defects on the laminate surface in order to further enhance the appearance of the laminate material.

### CROSS REFERENCE TO RELATED APPLICATIONS

This application claims priority from U.S. Provisional Patent Application Ser. No. 60/352,005, which was filed on Jan. 25, 2002.

### FIELD OF THE INVENTION

The present invention relates to coatings to laminate materials, and more specifically to a coating which enhances the appearance and gloss of a new or used laminate material.

### BACKGROUND OF THE INVENTION

Due to their ease of manufacture, installation and durability, laminate materials are often used in both residential and commercial environments. The laminate materials can be used as a floor covering, a countertop, or for just about any other decorative purpose where the exposed surface of an item is to be covered with a layer of the laminate having the desired appearance.

A large number of the laminate materials used for these purposes incorporate various components that enhance the desirable properties of the laminate material. One of these components is melamine, a component which provides various benefits to a laminate material with which it is used, such as increased durability and stain resistance. Normally, the additional component or components are applied to the laminate material after the material is formed in a protective coating on what will be the exposed surface of the laminate material, as this is the surface for which the enhanced properties are most necessary.

Unfortunately, the same protective coatings that enhance the properties of the laminate material also detrimentally affect the appearance of the material over time. More specifically, once the protective coating on the exposed surface of the laminate material becomes damaged or dirtied to the extent that the original appearance and/or gloss level of a laminate material is substantially reduced, the properties of the components found in the protective coating on the laminate material, such as melamine, effectively prevent any conventional appearance-enhancing or gloss-restoring coating or formulation from adhering to the protective coating in order to repair any defects in and renew the gloss level of the laminate material. As a result, the properties of the protective components applied to the laminate materials ensure that the appearance of the laminate material will dull over a sufficient amount of time.

Therefore, it is desirable to develop a laminate enhancer coating capable of adhering to a protective coating applied over a laminate material in order to repair and/or renew the original finish and gloss level of the laminate material. It is also desirable to develop an enhancer coating that, when applied over the laminate material, will not detrimentally affect the desirable qualities of the protective coating already present on the laminate material.

### SUMMARY OF THE INVENTION

It is an object of the present invention to provide a laminate enhancer coating capable of adhering to a protective coating covering the exposed surface of a laminate material in order to enhance the gloss level of the laminate material.

It is another object of the invention to provide a laminate enhancer coating capable of repairing scratches or other defects in the protective coating and the laminate material in order to improve the appearance of the laminate material.

It is still a further object of the invention to provide a laminate enhancer coating that can be easily modified in its formulation to adjust the level of gloss enhancement provided to the laminate material.

It is still another object of the invention to provide a laminate enhancer coating which can be easily applied to the surface of a laminate material in order to enhance the appearance of the material.

The present invention is a laminate enhancer coating capable of adhering to a laminate material having a protective coating and enhancing the appearance of the laminate material without impairing the beneficial qualities of the exposed protective coating. The enhancer coating includes a number of emulsion agents which enable the enhancer coating to stick to protective coating on the laminate material, as well as various other components which operate to enhance the gloss level and overall appearance of the laminate material on which the enhancer coating is applied. The ingredients for the enhancer coating are mixed with one another pursuant to an optimized method in order to prevent premature breaking down of the components of the enhancer coating prior to use. By combining the enhancer coating ingredients in this manner, the enhancer coating is formed to be a slightly viscous liquid which can easily be applied to the laminate material or packaged into containers for later use.

When used, the form of the enhancer coating allows the coating to be applied directly onto the protective coating of the laminate material and spread over the protective coating to completely cover the exposed surface. As the enhancer coating dries or cures over the laminate material, the enhancer coating effectively adheres to the protective coating of the laminate flooring, and provides an enhancement to the gloss level of the laminate material. Further, by placing one or more additional coats of the enhancer coating over the laminate material, minor imperfections, scratches, scuff marks or other damage done to the protective coating, and the exposed surface of the laminate material can be effectively filled in, covered and/or concealed by the enhancer coating.

Numerous other features, objects and advantages of the invention will be made apparent from the following detailed description.

### DETAILED DESCRIPTION OF THE INVENTION

The present invention is a gloss enhancing coating for a laminate material that includes an exposed decorative surface over which is placed a protective coating that is present to increase the durability of the laminate material and to repel stains. The enhancer coating of the invention adheres to and improves the appearance of the laminate material including the protective coating and also repairs minor defects or damage done to the exposed surface of the material. The enhancer coating is made in a process having a number of ordered mixing steps, in which the various ingredients of the coating are added to one another to form the enhancer coating.

The enhancer coating includes a number of components which allow the enhancer coating to perform as desired on the laminate flooring, i.e., to adhere to, to raise the gloss level of and to repair defects or scratches in the laminate material, including emulsion agents, dispersion agents, solvents and/or matting agents, among others.

The emulsion agents that are utilized in the enhancer coating provide various functions for the enhancer coating. For example, a first emulsion agent that is present in the enhancer coating is an acrylic emulsion. This type of emulsion has the characteristics of being able to improve the slip resistance, wet adhesion and block resistance of the enhancer coating to the laminate material without sacrificing any of the gloss or the exterior durability of the enhancer coating. Any type of suitable acrylic emulsion can be used, with a particularly preferred acrylic emulsion being NeoCryl XK-90, sold by NeoResins, Inc. of Wilmington, Mass. The most important feature of the acrylic emulsion component of the enhancer coating is that it enables the enhancer coating to adhere to the protective coating on the surface of the laminate material, such as a countertop or flooring, such that the enhancer coating will remain in place after application and curing on the laminate material. Therefore, in order to effectively provide this essential attribute to the enhancer coating, the acrylic emulsion is present in the enhancer coating in an amount ranging between 5% to 25% by weight of the enhancer coating, with a preferred range for the acrylic emulsion being between 10% and 20% by weight.

A second emulsion agent which is present in the enhancer coating is an acrylic/urethane copolymer emulsion. This type of emulsion provides the enhancer coating with various desirable properties in addition to those apparent in the enhancer coating due to the presence of the acrylic emulsion. For example, the acrylic/urethane copolymer emulsion provides the enhancer coating with increased hardness, flexibility and resistance to abrasion and chemicals when cured over the laminate material. As these attributes are also highly desirable in the enhancer coating, this type of emulsion forms a significant portion of the total enhancer coating composition, i.e., the acrylic/urethane emulsion is present in the coating in an amount between 45 and 75% by weight of the coating, and more preferably in an amount of between 50 and 60% by weight. One suitable and particularly preferred acrylic/urethane copolymer emulsion that can be used is Neo Pac R-9699 which is a hybrid emulsion of premixed AC/PU (acrylic and polyurethane resins) and is also sold by NeoResins, Inc.

While each emulsion agent provides benefits to the enhancer coating on its own, the combination of these two emulsion agents, i.e., the acrylic emulsion and the acrylic/urethane emulsion, form the basis for the adhesion of the cured or dry enhancer coating to the protective coating on the laminate material. Further, the use of both emulsion agents in conjunction with one another prevents the breakdown of either agent, which would otherwise occur if only one of the emulsion agents were used in formulating the enhancer coating.

The enhancer coating can also incorporate other emulsion agents that provide beneficial attributes to the enhancer coating in addition to those provided by the acrylic emulsion and the acrylic/urethane emulsion, as well as to enhance those attributes. One such emulsion agent that can be present in the enhancer coating is a wax dispersion. The wax dispersion can be formed with any suitable wax, i.e., natural or synthetic, that is dispersed in water, and that improves the scratch resistance of the applied enhancer coating, thereby giving the enhancer coating a “soft feel” after curing, and to control the resulting gloss level of the coating. The wax dispersion is present in the enhancer coating in an amount ranging between 0.1% and 10% by weight of the enhancer coating, with a range of between 0.5% and 4% being preferred. However, because this component also serves in part similarly to a matting agent to control the resulting gloss level for the coating, as discussed previously, the particular amount of the wax dispersion used in the enhancer coating depends upon the amounts of other matting agents present in the enhancer coating and the desired gloss level of the final, cured enhancer coating. A preferred wax dispersion to be used is Aquamat 208 which is sold by BYK-Cera of Deventer, the Netherlands and is formed of a dispersion of polyethylene wax in water.

The enhancer coating also preferably includes a dispersion agent as a component in order to effectively provide a generally homogeneous enhancer coating composition. The dispersion agent can be any agent that is compatible with the emulsion agents discussed above and present in the coating, and is present in an amount of between 0.5% and 10% by weight of the enhancer coating, and preferably between 1% and 5% by weight. A preferred dispersion agent is Ultralube® W 500-B, which is a high density polyethylene (HDPE) wax that not only effectively disperses the other enhancer coating components, but also provides scuff and mar resistance in addition to that provided by the other components.

To enable the enhancer coating to flow evenly over the laminate material and protective coating on which the coating is applied, the coating also preferably includes a wetting agent. The wetting agent enhances the ability of the enhancer coating to flow over the surface of the protective coating and laminate material by reducing the surface tension of the enhancer coating to prevent clumping or pooling of the enhancer coating such that the enhancer coating forms a level, and relatively even-thickness layer of the enhancer coating over the entire surface of the material. The wetting agent is present in an amount of 0.01% to 3% by weight of the coating, and preferably between 0.05% and 1% by weight. The particular wetting agent used in the coating can be any wetting agent capable of reducing the surface tension of a high solid content and/or aqueous formulation, with a particularly preferred wetting agent being an aqueous solution of about 5% by weight Fluorad FC-129, sold by 3M Specialty Materials of St. Paul, Minn.

Because one of the main functions of the enhancer coating is to enhance the gloss of the surface of a laminate material, the enhancer coating, in addition to the wax emulsion which has certain similar properties, also includes one or more separate matting agents that are used to control the gloss level of the enhancer coating when cured on the laminate material. The amount of the matting agent present in the coating can vary between 0.1% and 10% by weight of the enhancer coating, and preferably between 0.5% and 6% by weight. The particular amount of the matting agent or agents present in the enhancer coating is increased or decreased within this range depending on the amounts of any other gloss level-affecting components present in the enhancer coating in order to adjust the resulting gloss level provided by the enhancer coating as desired. A preferred matting agent is Acematt TS 100, sold by Degussa AG of Frankfurt, Germany.

In order to facilitate the proper application of the enhancer coating to the laminate material, a number of additional ingredients are preferably incorporated into the enhancer coating composition. These ingredients include defoaming agents that are utilized to dissipate any air bubbles that may form in the enhancer coating as it is applied to and cures on the laminate material, and solvents capable of dissolving the solid components added to the mixture during formation of the enhancer coating to form an easily applicable liquid enhancer coating.

With regard to the defoaming agents, the presence of the defoaming agents in the enhancer coating composition eliminates the formation of any air bubbles within the enhancer coating after application to the laminate material in order to provide a consistent, essentially transparent and smooth appearance to the enhancer coating as it cures on the laminate. Any conventional defoaming agent can be used, so long as the defoaming agent is compatible with the other components present in the enhancer coating. The defoaming agent is present in an amount of between 0.25% and 5% by weight of the enhancer coating, and preferably between 0.5% and 2% by weight. A preferred defoaming agent is Tego® Foamex 815, sold by Tego Coatings of Hopewell, Va. Further, more than one defoaming agent can be incorporated into the enhancer coating to provide increased defoaming properties for the enhancer coating so long as the total of the various weight percentages of each of the defoaming agents added to the enhancer coating falls within the above range.

The enhancer coating also includes a solvent utilized to dissolve the solid components of the coating and assist in creating an easy to apply, and slightly viscous liquid enhancer coating. Many solvents are suitable for use in the formation of the enhancer coating, but each solvent, or solvents if more than one is included in the enhancer coating formulation, must be compatible with the other solvents and/or components of the enhancer coating and must serve to dissolve the solid ingredients present in the enhancer coating in order to create a stable and flowable enhancer coating formulation. The solvent or solvents are preferably present in the coating in amounts of between 7% and 30% by weight of the enhancer coating, and preferably between 12% and 27% by weight. Also, as stated previously regarding the defoaming agents, when multiple solvents are present, the total amount of the various percentages of each of the solvents falls within this specified range. Preferred solvents which are utilized in conjunction with the other components specified for the enhancer coating include NMP (N-Methyl-2-Pyrrolidone), propylene glycol and water.

The enhancer coating is also preferably used in conjunction with a catalyst or hardener which, while forming a component of the cured enhancer coating, is not mixed with the enhancer coating until the enhancer coating is ready to be applied to the laminate surface. The catalyst or hardener, such as Aciridine, which is sold by Avecia of Wilmington, Del., is used to effect a more rapid curing of the enhancer coating when applied to a laminate, as well as to improve the scuff and stain resistance for the cured enhancer coating. More specifically, the hardener affects the reactions involving the emulsion agents to speed up the adhering of the enhancer coating to the protective coating on the laminate material and the hardening of the enhancer coating. The amount of hardener used with the enhancer coating is preferably about twenty (20) grams of the hardener per gallon of the enhancer coating. While the hardener greatly reduces the time necessary for the enhancer coating to cure on the laminate surface, the hardener can be omitted, in which case the enhancer coating cures more slowly upon application to the laminate material.

The enhancer coating may also include other additional components that provide other beneficial attributes, or perform other functions within the enhancer coating. For example, the enhancer coating can include one or more colorants, such as conventional pigments or dyes, which provide a desired color to the enhancer coating in order to more effectively cover up scratches in a similarly-colored laminate surface, and various thickeners, preferably formed of polyurethane, such as Collacral PU-85, sold by BASF of Ludwigshafen, Germany, that make the enhancer coating more spreadable over the laminate surface.

Having discussed the various components of the enhancer coating, the method of combining these components to formulate the enhancer coating will now be discussed. In order to properly combine the components of the enhancer coating to formulate the enhancer coating with the desired properties, initially the various emulsion agents, dispersion agents, wetting agents and matting agents to be used are intermixed with one another. These components are successively placed within a conventional mixing chamber or tank in no particular order. However, after the addition of each successive component, the formulation is mixed manually or mechanically for approximately eight (8) to twelve (12) minutes to thoroughly integrate the components with one another.

Next, the defoaming agent is added to the enhancer coating formulation. The formulation of the enhancer coating components is continually agitated during the addition of the defoaming agent to the formulation in order to ensure homogeneous mixing of the defoaming agent throughout the coating formulation. Furthermore, after the defoaming agent has been added to the enhancer coating formulation, the formulation is then agitated for an additional eighteen (18) to twenty-two (22) minutes to ensure that the defoaming agent is thoroughly mixed throughout the enhancer coating formulation.

After the defoaming agent has been added to the enhancer coating formulation and mixed therein, any additional defoaming agent or agents, if utilized, can be added to the formulation. The additional defoaming agent is preferably added to the formulation in a method similar to that employed for the initial defoaming agent, in that the additional defoaming agent is added while the enhancer coating formulation is being continuously mixed. Also, once the entire amount of the additional defoaming agent has been added to the coating formulation, the entire formulation again is mixed for an additional eighteen (18) to twenty-two (22) minutes to thoroughly mix the components.

While the main solid-containing ingredients of the enhancer coating formulation are added to one another and mixed together in the above steps, the solvent or solvents used in forming the enhancer coating are mixed separately. The primary reason for this is that, by maintaining the solvents separate from the emulsion agents used in the enhancer coating until the emulsion agents are effectively combined with one another, the emulsion agents are effectively prevented from prematurely being broken down by the solvents prior to the formation of the enhancer coating.

To mix the solvents, each of the solvents used, preferably NMP, propylene glycol and water are charged to a second mixing tank or chamber in any order and manually or mechanically mixed for approximately thirty (30) seconds. After the solvents are thoroughly mixed with one another, the resulting solvent mixture is added to the first tank holding the enhancer coating formulation including the emulsion agents, defoaming agents, wetting agents and melting agents. The solvent mixture and enhancer coating formulation are then mixed together for approximately eight (8) to twelve (12) minutes to produce the enhancer coating.

With regard to the colorants and thickeners that can optionally be added to the enhancer coating, these components can be added to the formulation either prior to or after the combining of the solvent mixture with the formulation. Also, after the formulation and the solvent mixture are integrated with one another, the resulting enhancer coating can then be transferred from the first mixing tank to one or more separate containers for retail sale or storage.

Once the enhancer coating has been prepared, in order to effectively apply the enhancer coating to a laminate material with a protective coating, first the protective coating and laminate must be thoroughly cleaned to remove oils, waxes, and other residues from the material. The enhancer coating can then be mixed with approximately twenty (20) grams of the catalyst per gallon of the coating or simply applied to the laminate surface, as described previously. If the hardener is added to the coating, the enhancer coating is shaken for approximately fifteen (15) to thirty (30) seconds to achieve the optimum effect of the hardener throughout the enhancer coating.

Once the enhancer coating is ready to be applied, the enhancer coating is poured directly onto the laminate surface. Preferably, the enhancer coating is poured onto the laminate surface in an approximately four (4) to six (6)-inch band and spread with any suitable or conventional pad evenly over the surface to form a thin layer of approximately between 1.5 to 2.5 mm of the enhancer coating over the laminate surface. Once the laminate surface is completely covered with the enhancer coating, the enhancer coating is left to dry or cure on the laminate surface for approximately four (4) to five (5) hours before any contact with the surface. The enhancer coating cures completely on the laminate surface after approximately seventy-two (72) hours. Further, in situations where significant scratches, abrasions or other defects are present in the laminate surface, to more effectively enhance the appearance of the laminate, a second application of the enhancer coating over the laminate surface will conceal the minor scratches and abrasions to the laminate surface by filling and/or covering them in order to further repair and enhance the appearance, of the laminate.

### EXPERIMENTAL

In a particularly preferred embodiment of the enhancer coating, the various ingredients of the enhancer coating are present in the amounts specified below in Table 1.

TABLE 1

| Component | Content % (w/w) |
|---|---|
| NeoPac R 9699 | 55.0 |
| NeoCryl XK 90 | 15.0 |
| Flourad FC 129 (5% w/w in water solution) | 0.5 |
| Ultralube ® W 500 B | 3.0 |
| Acematt TS 100 | 1.2 |
| Aquamat 208 | 2.0 |
| Tego ® Foamex 815 | 1.0 |
| Collacral PU-85 | 0.3 |
| NMP | 5.0 |
| Propylene glycol | 1.0 |
| Water | 16.0 |

The effectiveness of this enhancer coating in improving the gloss of a laminate surface, the chemical resistance of the enhancer coating, and the adhesion of the enhancer coating to the laminate surface was evaluated by performing various tests on this preferred formulation for the enhancer coating found in Table 1 after curing on a laminate surface. The test procedures used and the data obtained from the gloss, adhesion and chemical resistance tests performed by applying and curing the enhancer coating on various laminate surfaces will now be discussed.

Each of the laminate surfaces tested was a seven (7) inch wide by fifty-one (51) inch long section of a high pressure laminate including a final coat of melamine.

I. Gloss Enhancement

To test the effectiveness of the enhancer coating in improving or raising the gloss level of each laminate surface, the following testing procedure was utilized. Each laminate sample tested was initially measured at a sixty (60) degree angle using a gloss meter manufactured by BYK of Deventer, the Netherlands. The samples were then abraded to simulate wear and had their gloss levels measured again. The wear for the laminate material was simulated by abrading the laminate material with a 120 grit metal screen for between 7-10 seconds. The screen substantially scratched the surface of the laminate material without completely wearing through the laminate substrate. Only half of the sample was abraded in this manner so the gloss level resulting from the use of the enhancer coating could be compared with the original gloss level for the sample. The enhancer coating was then allowed to cure on the abraded laminate for approximately twelve (12) hours. Each sample included five (5) identical sections of the same laminate on which each gloss level test was performed. The range of gloss levels for each test done on the five (5) samples are as follows:

TABLE 2
GLOSS TESTING DATA

| | Initial Gloss Level | Abraded Gloss | Enhancer Gloss |
|---|---|---|---|
| Sample # | Range | Level Range | Level Range |
| 1 | 8-15 | 5-10 | ˜20 |
| 2 | 8-15 | 5-10 | ˜20 |
| 3 | 8-15 | 5-10 | ˜20 |
| 4 | 8-15 | 5-10 | ˜20 |
| 5 | 8-15 | 5-10 | ˜20 |

As shown from the above results, a single coat of the enhancer coating raised the gloss levels of the abraded samples above even the original gloss levels for each sample.

II. Adhesion

In order to test the effectiveness of the enhancer coating in adhering to the surface of the laminate material, a cross cut testing procedure was utilized. In this procedure, a tool is utilized that includes a steel blade having a number of tips on the blade spaced equally from one another. Depending upon the thickness of the coating to be tested, the blade to be used has tips that are spaced 1 mm, 2mm or 3 mm from one another. As the enhancer coating is preferably 1.5 to 2.5 mm thick when cured on a laminate material, a blade having tips spaced 3 mm apart was used. The enhancer coating was applied to and allowed to cure completely on the samples. In the two sets of tests performed, the enhancer coating was allowed to cure for twelve (12) hours and twenty-four (24) hours, respectively. The blade tips were then pressed into the cured coating and used to make a first series of cuts completely through the coating. The tool was then rotated and the tips were used to make a second series of cuts through the coating perpendicular to the first series, resulting in a number of 3×3 mm squares being formed in the coating. The same procedure was then repeated in two other spots on the coating to form identical size squares. The squares were initially inspected for any chipping or adhesion failure immediately after forming the squares. Because no instances of chipping or adhesion failure were found, a piece of duct tape was then applied flat over each of the sections of squares. Two of the pieces of tape were immediately removed from the coating after application and the number of chipped squares or squares removed from the laminate was determined. The third piece of tape was removed after remaining on the coating for twenty-four (24) hours and the number of squares removed or chipped was ascertained. The results of these tests are shown in Table 3.

TABLE 3
ADHESION TESTING DATA

| | | # of squares removed by tape | | |
|---|---|---|---|---|
| | # of squares chipped or | 12 hours | | |
| Sample # | removed after cutting | strip 1 | strip 2 | 24 hours |
| 1 | 0 | 0 | 0 | 0 |
| 2 | 0 | 0 | 0 | 0 |
| 3 | 0 | 0 | 0 | 0 |
| 4 | 0 | 0 | 0 | 0 |
| 5 | 0 | 0 | 0 | 0 |

As shown in the results of Table 3, in each test for adhesion performed on the enhancer coating, none of the squares of the coating were removed, such that enhancer coating achieved 100% adhesion (GTO) to the protective coating present on the laminate material.

III. Chemical Resistance

Finally, the enhancer coating was also tested for its chemical resistance to a number of different compounds. In performing these tests, after applying the enhancer coating to the laminate surface test samples of the laminate of sample #1 and allowing the enhancer coating to cure for twelve (12) hours, the various compounds to be tested were placed on the enhancer coating and allowed to remain on the enhancer coating until a visible change (such as a color change, a gloss level change or swelling in the enhancer coating) in the enhancer coating occurred or until twenty-four (24) hours elapsed, whichever came first. The following results were obtained from these tests:

TABLE 4
CHEMICAL RESISTANCE TESTING DATA

| | Time of Exposure Without Effect | |
|---|---|---|
| Chemical | (color/sheen/swelling) | |
| Vinegar acid 7% | 5 | h |
| Citric Acid | 24 | h |
| Sodium carbonate | 24 | h |
| Ammonia water | 24 | h |
| Ethanol 48% Water | 24 | h |
| White/Red wine | 24 | h |
| Beer | 24 | h |
| Cola beverage | 24 | h |
| Coffee | 24 | h |
| Black Tea | 24 | h |
| Black Raspberry Juice | 24 | h |
| Condensed milk | 24 | h |
| Water | 8 | h |
| Petrolether | 24 | h |
| Acetone | 2 | min. |
| Ethyl/Buthylacetate 1:1 | 1 | h |
| Butter | 24 | h |
| Olive Oil | 24 | h |
| Mustard | 24 | h |
| Saturated Salt solution | 24 | h |
| Onion | 24 | h |
| Lipstick | 24 | h |
| Desinfective (Buraton) | 24 | h |
| Ball Point pen ink | 2 | min. |
| Stamp ink | 24 | h |

The exposure times for the samples including the enhancer coating are significantly greater than the times for the laminate surface without the enhancer coating.

Therefore, based on the above test data, the enhancer coating of the present invention provides significant benefits to worn or used laminate surfaces by improving both the gloss level and chemical resistance of the surfaces while also providing more than adequate adhesion to the laminate surface.

Various alternatives are contemplated as being within the scope of the following claims particularly pointing out and distinctly claiming the subject matter regarded as the invention.

I claim:

1. An enhancer coating for a laminate material having a protective exterior coating, the enhancer coating comprising:
a) a first emulsion agent
b) a second emulsion agent;
c) at least one matting agent; and
d) at least one solvent, wherein the first emulsion agent is an acrylic emulsion and wherein the second emulsion agent is an acrylic/urethane emulsion.

2. The coating of claim 1 further comprising:
a) 5% to 25% by weight of the first emulsion agent; and
b) 45% to 75% by weight of the second emulsion agent.

3. The coating of claim 1 further comprising 0.1% to 10% by weight of the at least one matting agent.

4. The coating of claim 1 further comprising 7% to 30% by weight of the at least one solvent.

5. The coating of claim 1 further comprising a hardener.

6. The coating of claim 1 wherein the at least one solvent is selected from the group consisting of: NMP, propylene glycol, water, and mixtures thereof.

7. The coating of claim 1 further comprising at least one wetting agent.

8. The coating of claim 1 further comprising at least one defoaming agent.

9. The coating of claim 1 further comprising a colorant.

10. The coating of claim 1 further comprising at least one dispersion agent.

11. A method for forming an enhancer coating for a laminate material having a protective exterior coating, the method comprising the steps of:
a) forming a coating formulation of a first emulsion agent, a second emulsion agent and at least one matting agent, wherein the first emulsion agent is an acrylic emulsion and the second emulsion agent is an acrylic/urethane emulsion;
b) forming a solvent mixture; and
c) adding the solvent mixture to the coating formulation.

12. The method of claim 11 further comprising the step of adding at least one defoaming agent to the coating formulation after forming the coating formulation.

13. The method of claim 11 wherein the step of forming the coating formulation comprises the steps of:
a) placing one of the first emulsion agent, the second emulsion agent and the at least one matting agent in a mixing chamber;
b) adding another of the first emulsion agent, the second emulsion agent and the at least one matting agent to the mixing chamber;
c) agitating the mixing chamber;
d) adding the remaining one of the first emulsion agent, the second emulsion agent and the at least one matting agent to the mixing chamber; and
e) agitating the mixing chamber.

14. The method of claim 11 further comprising the step of adding one of a colorant, a thickener or a mixture thereof to the coating formulation after adding the solvent mixture to the coating formulation.

15. The method of claim 11 further comprising the step of adding one of a colorant, a thickener or a mixture thereof to the coating formulation prior to adding the solvent mixture to the coating formulation.

16. The method of claim 11 further comprising the step of adding a hardener to the coating formulation after adding the solvent mixture.

17. A method for applying an enhancer coating to an exterior surface of a laminate material having a protective exterior coating, the method comprising the steps of:
a) providing an enhancer coating including a first emulsion agent formed of an acrylic emulsion, a second emulsion agent formed of an acrylic/urethane emulsion, at least one matting agent and at least one solvent;
b) cleaning the exterior surface of the laminate material;
c) applying the enhancer coating over the exterior surface of the laminate material; and
d) allowing the enhancer coating to cure on the exterior surface of the laminate material.

18. The method of claim 17 wherein the step of applying the enhancer coating comprises:
a) adding a hardener to the enhancer coating after cleaning the exterior surface of the laminate material; and
b) spreading the enhancer coating over the exterior surface of the laminate material.

19. The method of claim 17 further comprising the step of allowing the laminate material to dry after cleaning the exterior surface of the laminate material.

20. A laminate surface comprising:
a) a laminate substrate having an exterior surface;
b) a protective coating on the exterior surface of the laminate substrate; and
c) an enhancer coating on the protective coating opposite the laminate substrate, the enhancer coating including a first emulsion agent, a second emulsion agent, at least one solvent and at least one matting agent, wherein the first emulsion agent is an acrylic emulsion and the second emulsion agent is an acrylic/urethane emulsion.
